(19) United States
(12) Patent Application Publication
(10) Pub. No.: US 2015/0324108 A1
(43) Pub. Date: Nov. 12, 2015

(54) SYSTEM AND METHOD OF CALCULATING TIME BASED METRICS

(71) Applicant: James R. STABILE, Newton, NJ (US)

(72) Inventor: James R. STABILE, Newton, NJ (US)

(21) Appl. No.: 14/710,137

(22) Filed: May 12, 2015

Related U.S. Application Data
(60) Provisional application No. 61/991,856, filed on May 12, 2014.

(51) Int. Cl. G06F 3/0484; G06F 3/0482

(52) U.S. Cl. CPC G06F 3/04847; G06F 3/0482; G06F 3/04842

(57) ABSTRACT

A system and method for generating a number of differing metrics is described and taught. Generally, the metrics are related but not limited to aeronautics and flying, and may be used for a variety of fields and purposes. The generated electrical signal produced by a transducer type sensor is typically but not limited to a time based metric that can be readily converted to and from a number of statistical measures. Thus, from the same electrical signal gathered by the system, metrics relating to weight, pressure, volume, etc. can be calculated and displayed singularly or simultaneously to provide a calculation specific to that industry such as time remaining. Some of the metric values may be stored on a memory for use at a later time. Additionally, a displayed metric that falls outside of a generally accepted range for that metric may generate an audible and/or visual alarm.

### CLAIM OF PRIORITY

This application claims the priority of U.S. Ser. No. 61/991,856 filed on May 12, 2014, the contents of which are fully incorporated herein by reference.

### FIELD OF THE EMBODIMENTS

This invention and its embodiments relates to a system and method for displaying to a user the time remaining for use of a varying number of metrics including the time remaining for a particular variable such as the amount of oxygen remaining in a container.

### BACKGROUND OF THE EMBODIMENTS

Most data is nowadays is transmitted and operated on through electronic means. This provides for digital interpretations of the data that can be readily shown to a user. For example, a gas gauge in a car typically has a needle that points to “full,” “empty,” or some point therebetween. Some cars now have digital dashboards, where a digital representation of the physical gauge is now in its place. The same type of technology is also used in aviation to create high contrast screens providing superior visual cues to pilots. While such uses of digital technology is useful, the technology is still in its infancy and many improvements can still be made thereto.

Currently, technology allows for a device that can measure a metric and then show a digital representation of that metric. However, it would be advantageous to have a digital gauge that can transform an electrical signal into a variety of metrics in order to suit one's particular needs. Additionally, such metrics could be displayed simultaneously giving an accurate portrayal on one screen of necessary information. The present invention and its embodiments meets and exceeds these objectives.

### Review of Related Technology:

U.S. Pat. No. 8,359,171 pertains to an electronic pressure gauge for measuring the pressure inside a container, particularly a pressurized gas cylinder, said pressure gauge including: at least one pressure sensor; an electronic unit designed to acquire, store and process data; and at least one information device capable of transmitting at least one item of information. The pressure gauge also includes a first radio with a reception port, said first radio being connected to the electronic unit so as to receive external data in order to modify the operation or the configuration of the pressure gauge. The reception port of the first radio is designed to read data modulated in terms of the frequency and/or intensity of an external magnetic field at a first low frequency, for example a frequency between 50 and 300 kHz.

U.S. Pat. No. 7,104,124 pertains to a system for identifying the time remaining for a bottled gas supply to lapse. Such bottled gas supplies include those used for gas grilles, scuba, nitrogen for electron microscopes, and any other environment in which a bottled gas is used. The system reads the pressure and optionally the temperature of the gas container, the readings of which are read by a microprocessor, optionally first pre-processed in a conversion module, and converted into a display for the user identifying the time during which the gas contents remaining will last. In various systems, it may be desirable to program the microprocessor, such as with input from a keyboard and/or CD-ROM, with parameters regards specifics of the gas or the container, or to simply processing by assuming a certain temperate correlation and thereby eliminate the need for a temperature transducer.

U.S. Patent Application 2009/0126482 pertains to a gas measurement apparatus. The sensor can measure a pressure condition of a gas tank, in an example. The processor can select at least one light source, the light source can be positioned or be of a distinct color to indicate a corresponding level of gas remaining in the tank when illuminated. The level of gas can be based on the measured pressure. Banks of high intensity LEDs can allow visually discernable colors at a significant distance underwater. A visual beacon mode can be included. An alphanumeric pressure readout mode can be included. A depth sensor can be included.

Various devices are known in the art. However, their structure and means of operation are substantially different from the present disclosure. The other inventions also fail to solve all the problems taught by the present disclosure. Such gauges measure physical properties (i.e. pressure) whereas the present invention measures time based metrics dependent on known properties. Thus, the present invention and its embodiments provide for a virtual gauge that can display a number of metrics generated from an electrical signal based on a number of internal algorithms. At least one embodiment of this invention is presented in the drawings below and will be described in more detail herein.

### SUMMARY OF THE EMBODIMENTS

Generally, the present invention describes and teaches a virtual gauge that generates a number of interrelated time based metrics. Typically such a system would be used in an airplane, but applications may include almost any field of endeavor.

An electrical signal is collected through hardware or a wireless connection. A processor, preferably having a memory, then manipulates the signal into a variety of solutions using the processor. The underlying theme with the metrics being that the value calculated is based off of the “time remaining” for the given metric. For example, one could seamlessly pull up the time, or amount, remaining in an oxygen supply based on the pounds per square inch (PSI) of the oxygen remaining and such a pressure based metric could be displayed in liters, bars, hectopascals, percentage of full, or even a derived flow rate based on delta P, etc.

The present invention and its embodiments describe and teach a system for virtually displaying an electrical signal as a plurality of metrics, the system having an electrical system that produces at least one data signal, wherein the at least one data signal originates from at least one transducer; a microprocessor having a memory that manipulates the at least one data signal; and a visual display that outputs the manipulated data signal into a plurality of metrics, wherein the visual display graphically depicts more than one of the plurality of metrics simultaneously.

In another aspect of the invention there is a method for determining a number of metrics based on an electrical signal, the method having the steps of: providing a computer processor with a display and an interface; the computer processor receiving an electrical signal from at least one transducer; and a user inputting a command to dictate at least one metric to display on the interface.

In yet another aspect of the present invention there is a non-transitory computer readable medium to provide a data conversion program having instructions stored thereon that when executed on a computer cause the computer to perform the steps of: receiving an electrical signal, wherein the electrical signal is obtained via hardwired or wireless mechanisms; processing the electrical signal with at least one algorithm into separate calculations; and displaying any of the separate calculations.

In general, the present invention succeeds in conferring the following, and others not mentioned, benefits and objectives.

It is an object of the present invention to provide a system that can calculate a time based metric.

It is an object of the present invention to provide a system that provides an efficient solution to critical measurements.

It is an object of the present invention to provide a system that graphically displays information.

It is an object of the present invention to provide a system that readily converts an electrical signal into different units of measurement.

It is an object of the present invention to provide a system that alerts a user to a displayed value that is outside an accepted range for that value.

It is an object of the present invention to provide a system that creates a distinct visual display to discern multiple metrics when displayed at once.

### BRIEF DESCRIPTION OF THE DRAWINGS

FIG. 1 is a schematical overview of a system in accordance with a preferred embodiment of the present invention.

FIG. 2 is a flowchart illustrating a method of use of a preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

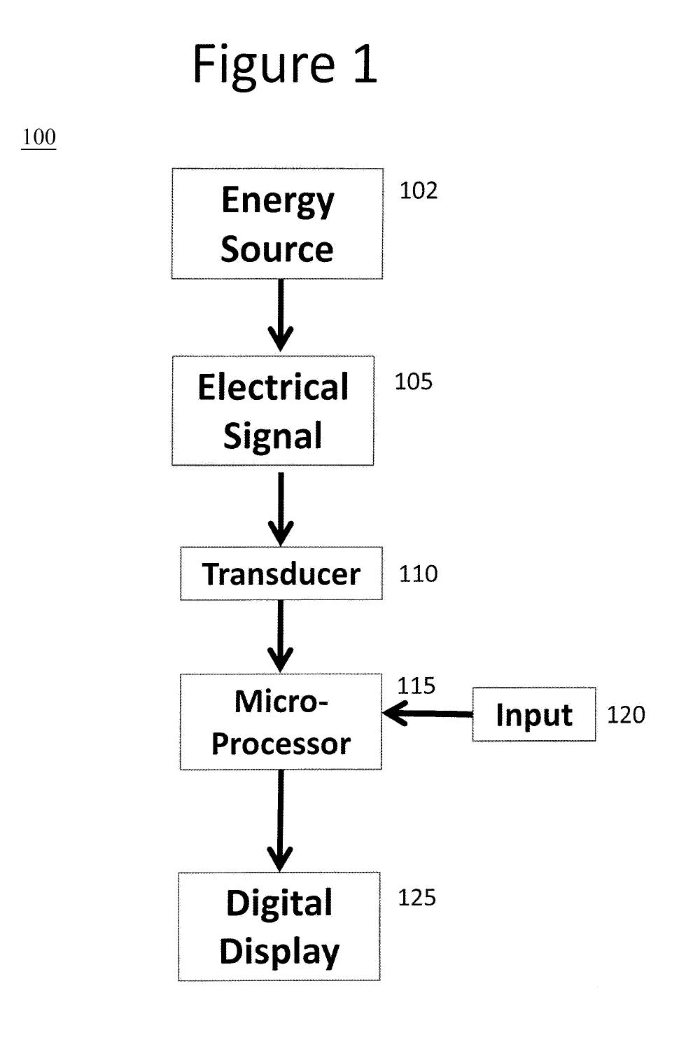

Referring now to FIG. 1, there is a flowchart illustrating a schematical overview of an embodiment of the present invention. The system 100 overview shown in FIG. 1 features some type of energy source 102. For example, the energy source 102 may comprise the wiring and sensors of an airplane or the similar components of an electrical grid for a municipality.

The energy source 102 generates an electrical signal 105. The electrical signal 105 may include data collected by the sensors associated with the energy source 102. These sensors may include those typically found on an airplane including but not limited to fuel and other fluid gauges, sound collection devices, global positioning systems, and the like or some combination thereof. Further, the electrical signal 105 may be multiple signals carrying a variety of data from multiple systems or emanating from multiple sensors within a single system.

Depending the on the type of signal generated, a transducer 110 may be used to transform the signal from one form or type to another. For example, if a sound collecting sensor, such as a microphone, is employed in an energy source 102 then the sound generated must be transformed by the transducer 110 into an electrical sound signal for processing by the system.

Once the electrical signal 105 has been operated on, if necessary, a microprocessor 115 processes the signal. The microprocessor 115 enables a machine such as a computer to interpret the electrical signal 105 and parse the electrical signal 105 in accordance with its programming or a program running on the computer. The output of the microprocessor 115 is displayed on a visual display 125 that is preferably a digital display. The visual display 125 provides a visual readout of the calculations performed based on the data collected by the system 100. An input 120 may be used to select which metric to display, or to modify the parameters of the system in accordance with a particular need.

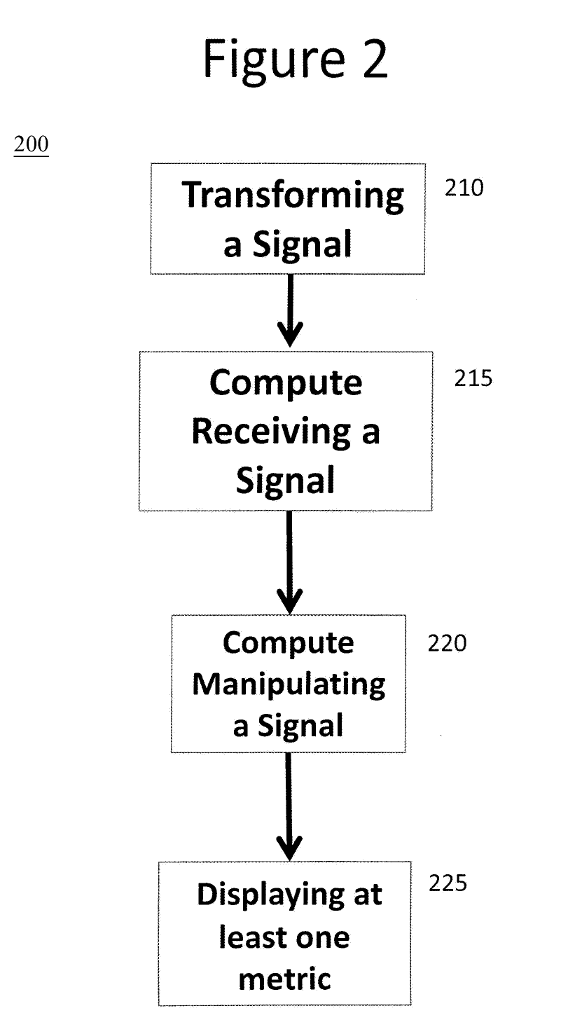

In FIG. 2 there is a flowchart illustrating a method 200 of determining any number of metrics based on a collection of data. A computer is provided for use with interpreting a data signal such as one described above in FIG. 1. The computer may be one or more of any number of devices capable of collecting and interpreting data including but not limited to a laptop computer, desktop computer, PC, PDA, smart phone, gaming system, tablet, e-reader, wearable computers, smart watches, multimedia players, and the like or any combination thereof. The computer is preferably connected either through a hardwired or wireless connection to a system that generates data. Such a system may have a number of sensors or data capturing modules that are capable of collecting information and sending it to the computer.

In step 210, the transmitted signal is transformed. This step may be optional depending on the source of the collected signal. For example, a purely electrical signal may be capable of being interpreted by the system, whereas a signal that originates from a light, sound, or flowing gases, would have to be first transformed from their originating medium into a signal capable of being processed by the computer (i.e. electrical). This step is preferably achieved using a transducer or other similarly situated component.

In step 215, the computer receives the signal from the surrounding system. The signal may contain one data stream or have a number of parsable components within the single data stream. Additionally, the computer may be receiving multiple signals from the same system or multiple signals from differing systems.

In step 220, the computer manipulates the signal. This is achieved by operating on the signal via any number of calculations to arrive at the solution desired by a user. The solutions may include similar outputs or comprise varying outputs to be calculated from the same signal. Thus, from one signal one may be able to ascertain a flow rate of a gas and the pressure of the gas. The computer has a number of built in algorithms that can supply virtually a limitless amount of calculations and outputs based on a given data signal. The computer may run a program stored on a non-transitory computer readable medium that includes instructions for making such calculations.

In a step 225, at least one metric is displayed on a visual display. The visual display is a visual output that may be displayed on any number of articles of manufacture. The visual display may have touch sensitive capabilities that allows for manipulation of the data shown on the display. Additionally, there may be an input such as a keyboard, either physical or virtual, that allows for the input of data or instructions.

Generally, the present invention and embodiments thereof described in FIGS. 1-2 are applicable to the field of aeronautics, but may be used under conceivably any system. The system generally takes electrical signals 105 and interprets them in a way to create numerous calculations from a single signal. Thus, a user can employ the system to divide the signal and use the computer to create an output to fit their particular needs.

A preferred calculation for the system to perform is for “time remaining.” The time remaining calculation can suit a number of needs including providing a window for which an airplane, jet, glider, and the like can be flown after emergency decompression of the cabin. Further, the time remaining calculation could be placed in numerous base units (i.e. 23:00 on 82 PSI). Other calculations that may be achieved using the system include pressure (i.e. PSI, bars, Pa, Torr, atm), volume, percentage of full, flow rates, and the like. Any calculation can readily be performed for English, Imperial, Metric, or other measurement system units alike. Virtually any time based metric can be calculated and converted from one unit to another with the system.

Ideally, such a system would manifest itself as a virtual gauge in an airplane. This one gauge can become a virtual library of solutions for calculating time remaining based metrics. This enables pilots to make advanced, strategic decisions based on the information gleaned from this gauge. The virtual gauge enables a plethora of functionality including the ability to display multiple metrics and/or calculations simultaneously. The virtual gauge can also create alerts when the given metric falls outside of an accepted range for that metric. The gauge may interact with multiple systems such as a global positioning system thereby enabling informed decisions to be made based on the time remaining metrics in relation to location.

Further, varying metrics may be displayed in different colors to create a visual contrast and avoid confusion between displayed metrics. For example, a first metric may be presented in a first color and a second metric may be presented in a second color. If the value for one of the metrics exceeds or falls below an accepted value the metric may be displayed in a third color. The third color may be consistently displayed by any of the metrics once that particular metric has fallen outside its own accepted values.

Conversely, such technology may be employed in conjunction with a propane tank generating an electrical signal. An individual can then visually inspect the propane tank to ascertain a number of characteristics such as the amount of time remaining (how much propane is left), pounds remaining, kilograms remaining, percentage of full remaining, or any other germane metric. This information may be able to be monitored wireles sly with an electronic device such as a smart phone or tablet enabling one to have quick access and continual monitoring of such metrics.

Further, the technology could be used in a helium tank to manage the energy left in the system. The metric may display the given number of balloons that can still be inflated given an average balloon volume. Additionally, the technology may be used to depict the number of shots remaining in a paintball gun based on the monitoring of the carbon dioxide canister. Overall, the above examples are not meant to be limiting, but rather to demonstrate the wide range of applicable uses for the described technology. The varying metrics make for an almost limitless number of possibilities.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A system for virtually displaying an electrical signal as a plurality of metrics, the system comprising:
a system that produces at least one data signal,
at least one transducer,
wherein the at least one transducer transforms the at least one data signal;
a microprocessor having a memory that manipulates the at least one data signal; and
a visual display that outputs the manipulated data signal into a plurality of metrics,
wherein the visual display graphically depicts more than one of the plurality of metrics simultaneously.

2. The system of claim 1 wherein the system calculates and displays time remaining for a given metric.

3. The system of claim 2 wherein the system calculates and displays a pressure based metric.

4. The system of claim 2 wherein the system calculates and displays a weight based metric.

5. The system of claim 2 wherein the system calculates and displays a rate of flow metric.

6. The system of claim 2 wherein the system calculates and displays a usage based metric.

7. The system of claim 2 wherein the system calculates and displays a volume based metric.

8. The system of claim 2 wherein the system calculates and displays a time based metric.

9. The system of claim 1 further comprising an input mechanism that enables an input value related to the displayed metric.

10. A method for determining a number of metrics based on an electrical signal, the method comprising the steps of:
a) providing a computer processor with a display and an interface;
b) at least one transducer transforming a signal;
c) the computer processor receiving the signal from at least one transducer;
d) the computer processor manipulating the signal via preinstalled firmware; and
e) a user inputting a command to dictate at least one metric to display on the interface.

11. The method of claim 10 wherein there is more than one metric displayed from the same signal simultaneously.

12. The method of claim 10 further comprising the step of:
storing at least one metric in a memory of the computer processor.

13. The method of claim 12 wherein the at least one metric is compared to a subsequent reading of the same metric.

14. The method of claim 10 wherein the metric is based on an amount of time remaining for the given metric.

15. The method of claim 10 further comprising the step of:
generating an alert when a displayed metric is in conflict with an accepted range of that metric.

16. The method of claim 10 wherein different metrics are displayed in different colors.

17. A non-transitory computer readable medium to provide a data conversion program having instructions stored thereon that when executed on a computer cause the computer to perform the steps of:
receiving an electrical signal,
wherein the electrical signal is obtained via hardwired or wireless mechanisms;
processing the electrical signal with at least one algorithm into separate calculations; and
displaying any of the separate calculations on a visual display.

18. The non-transitory computer readable medium of claim 17 wherein the calculations are time based.
